(19) United States
(12) Patent Application Publication
(10) Pub. No.: US 2007/0129106 A1
(43) Pub. Date: Jun. 7, 2007

(54) Remote Control System Capable of Controlling an Electronic Device at Different Modes and Method Thereof

(76) Inventor: Wei-Hung Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/308,076

(22) Filed: Mar. 6, 2006

(30) Foreign Application Priority Data
Dec. 7, 2005 (TW) 094143153

(51) Int. Cl. H04M 1/00

(52) U.S. Cl. 455/556.1; 340/825.69

(57) ABSTRACT

A method for controlling an electronic device at different modes includes the following steps: transmitting wireless signals corresponding to a mode control code corresponding to a function mode of the electronic device by wireless communication technology; transmitting wireless signals corresponding to a function code corresponding to a function instruction of the electronic device by wireless communication technology; and performing the function of the electric device corresponding to the function instruction of the function code corresponding to the mode code. The method overcomes the defect of a conventional remote controller where each keypad only corresponds to one function, while at the same time the method also overcomes the inconvenience of a bulky remote controller having too many keypads.

### BACKGROUND OF THE INVENTION

1. Field of the Invention

The present invention relates to a remote control system and related method, and more particularly to a remote control system and its related method capable of controlling an electronic device at different modes.

2. Description of the Prior Art

A remote controller has become an essential electronic device in our modern daily life. A user is able to select specific channels on the television or control the temperature of the air conditioner by controlling the remote controller without any need for moving about. Please refer to FIG. 1. FIG. 1 illustrates a functional block diagram of a conventional remote controller 10. The remote controller 10 includes an input interface 12, which includes a plurality of keypads for selecting a function corresponding to each keypad by the user; a control module 14 coupled to the input interface 12; and an infrared light-emitting diode (LED) 16 coupled to the control module 14. The user can select a function corresponding to each keypad through the input interface 12, and the input interface 12 can transmit an input signal corresponding to each keypad to the control module 14. The control module 14 generates an infrared control signal similar to a Morse code to control the infrared LED 16 to transmit an infrared signal corresponding to the control module of an electronic device. When the electronic device receives the infrared signal, the infrared signal is decoded and the corresponding function is then executed, for example, volume adjustments, or image adjustments.

When the infrared LED 16 transmits an infrared signal, the infrared signal carries a function code corresponding to the function. A machine identity code is inserted (i.e., added) before the function code for identifying the electronic device to be controlled. An ending code is appended (i.e., added) after the function code to separate the data in the continuous signals. During the operation of conventional remote control technology, each function of an electronic device is fixed to and corresponds to a remote control signal of predetermined information. The specific remote controller for the electronic device has keypads installed for controlling different functions; to control a function on a keypad for the remote controller to transmit the remote control signal of the predetermined function information such as an infrared signal or a magnetic signal. When the user controls the electronic device to execute a function, the user presses a keypad on the remote controller that corresponds to the desired function thereby causing the remote controller to transmit a remote control signal wherein the remote control signal carries the predetermined information corresponding to the said function. When the remote control signal is received, the electronic device will determine the predetermined data of the remote control signal and then execute the function corresponding to the predetermined information according to a corresponding relationship between the predetermined information and the function.

Therefore, each keypad on the input interface 12 of the conventional remote controller 10 corresponds to a function, and can only be utilized under a function mode. The corresponding relationship between each function and each predetermined information of each remote control signal of the electronic device is already fixed; built-in into the electronic device, and forms a one-to-one corresponding relationship. In this one-to-one corresponding relationship, the user is constrained to the parameters of the predetermined design of the remote controller therefore the user's actions when utilizing the remote controller can only follow accordingly to said predetermined design. The user cannot set the keypad/control allocation on the remote controller according to their desire. For example, if the functions on the specific remote controller are too complex and the remote controller has too many keypads, a young person or an elderly person will find it difficult to operate and may accidentally press other unnecessary keypads. Additionally, the complex remote controller having many keypads results in the size of the remote controller to be bulky. Therefore, the remote controller is not in synchronicity with the modern trend of miniaturization, convenience, and multi-functional design.

### SUMMARY OF THE INVENTION

The claimed invention discloses a remote control system capable of controlling an electronic device at different modes. The remote control system comprises a remote controller comprising a mode input interface for inputting a mode control code corresponding to a function mode of the electronic device; a function input interface for inputting a function control code corresponding to a function instruction of the electronic device; a first wireless transmission module for transmitting wireless signals; and a control module for controlling the first wireless transmission module to output the wireless signals corresponding to the mode control code when the mode input interface receives the mode control codes. The remote control system further comprises an electronic device comprising a memory for storing a corresponding relationship between the mode control code and the function control code and a corresponding relationship between the function control code and the function instruction; a second wireless transmission module for receiving the wireless signals corresponding to the mode control code transmitted from the first wireless transmission module or for receiving the wireless signals corresponding to the function control code transmitted from the first wireless transmission module; and a logic unit for controlling the electronic device to execute a function of the function instruction corresponding to the function control code of the mode control code according to the wireless signals corresponding to the mode control code received by the second wireless transmission module, the wireless signals corresponding to the function control code received by the second wireless transmission module, the corresponding relationship between the mode control code and the function control code stored in the memory, and the corresponding relationship between the function control code and the function instruction stored in the memory.

The claimed invention discloses a method capable of controlling an electronic device at different modes. The method comprises utilizing a wireless communication technology to transmit wireless signals corresponding to a mode control code corresponding to a function mode of the electronic device to the electronic device; utilizing the wireless communication technology to transmit the wireless signals corresponding a function control code corresponding to a function instruction of the electronic device; and the electronic device executing a function of the function instruction corresponding to the function control code of the mode control code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a conventional remote controller.

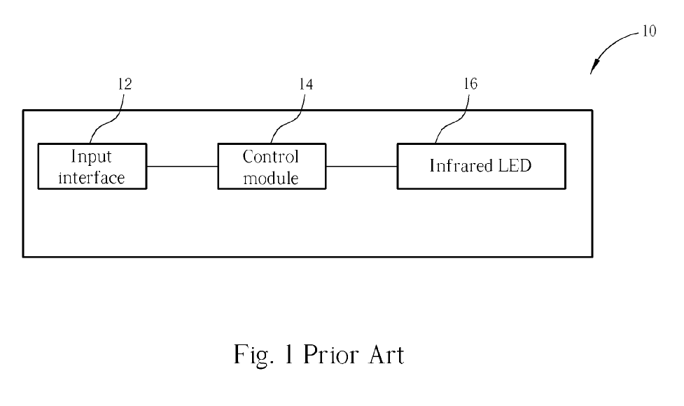

FIG. 2 illustrates a diagram of a remote control system according to the present invention.

FIG. 3 illustrates a functional block diagram of a remote control system.

FIG. 4 illustrates to a flowchart of a remote controller remotely controlling an electronic device according to a remote control system of the present invention.

FIG. 5 illustrates a diagram of a corresponding relationship between a mode control code and a function control code and a corresponding relationship between a function control code and a function instruction stored within a memory according to the present invention.

### DETAILED DESCRIPTION

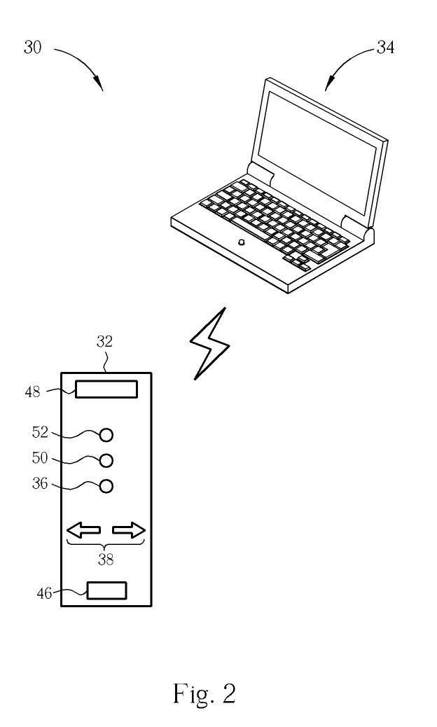

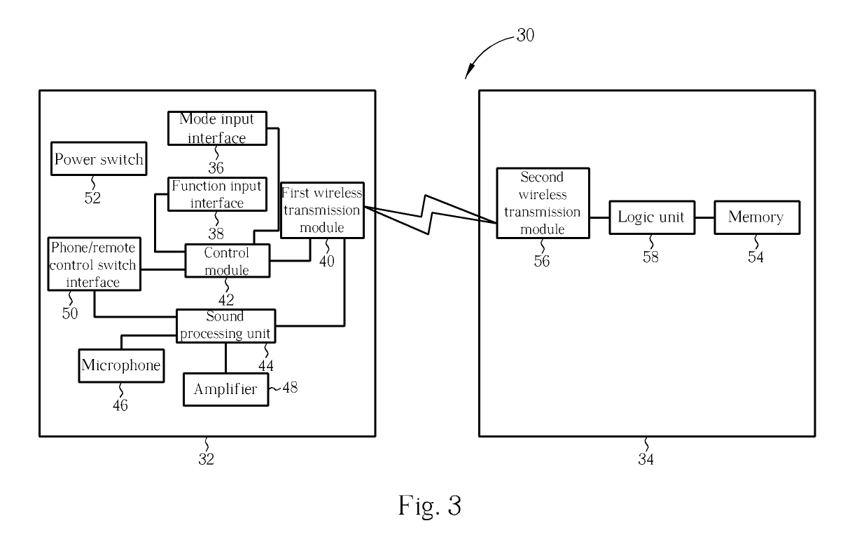

Please refer to FIG. 2 and FIG. 3. FIG. 2 illustrates a diagram of a remote control system 30 according to the present invention. FIG. 3 illustrates a functional block diagram of a remote control system 30. The remote control system 30 includes a remote controller 32 for remotely controlling an electronic device 34, which can be a voice over Internet protocol (VoIP) phone, the remote controller 32 includes a mode input interface 36 for inputting a mode control code corresponding to a function mode of the electronic device 34, which can be presented as a keypad; a function input interface 38 for inputting a function control code corresponding to a function instruction of the electronic device, which can be presented as a keypad; a first wireless transmission module 40 for transmitting wireless signals; and a control module 42 for controlling the first wireless transmission module 40 to output the wireless signals corresponding to the mode control code when the mode input interface receives the mode control codes, and the control module 42 is also utilized for outputting the wireless signals corresponding to the function control code when the function input interface 38 receives the function control code. The remote controller 32 is a VoIP phone, thus the remote controller 32 further includes a sound processing unit 44 coupled to the first wireless transmission module 40 for processing audio signals; a microphone 46 coupled to the sound processing unit 44 for converting sound waves into an audio signal and for transmitting the audio signal to the sound processing unit, wherein the sound processing unit 44 is capable of controlling the first wireless transmission module 40 to transmit the audio signal a wireless manner; and an amplifier 48 coupled to the sound processing unit 44 for converting data transmitted from the sound processing unit 44 into sound waves. Furthermore, the remote controller 30 includes a phone/remote control switch interface 50 coupled to the sound processing unit 44 and the control module 42 for switching to a phone function or a remote control function, which can be presented as a keypad; and a power switch 52 for turning on or off the remote controller 30.

The remote control system 30 further includes the electronic device 34. For example, the electronic device 34 can be a notebook computer. The electronic device 34 includes a memory 54 for storing a corresponding relationship between the mode control code and the function control code and a corresponding relationship between the function control code and the function instruction; a second wireless transmission module 56 for receiving the wireless signals corresponding to the mode control code transmitted from the first wireless transmission module 40 or for receiving the wireless signals corresponding to the function control code transmitted from the first wireless transmission module, wherein the first wireless transmission module 40 utilizes an infrared transmission technology or a wireless area network protocol, for example, Bluetooth technology, to transmit the wireless signals and the second wireless transmission module 56; and a logic unit 58 for controlling the electronic device 34 to execute a function of the function instruction corresponding to the function control code of the mode control code according to the wireless signals corresponding to the mode control code received by the second wireless transmission module 56, the wireless signals corresponding to the function control code received by the second wireless transmission module 56, the corresponding relationship between the mode control code and the function control code stored in the memory 54, and the corresponding relationship between the function control code and the function instruction stored in the memory 54.

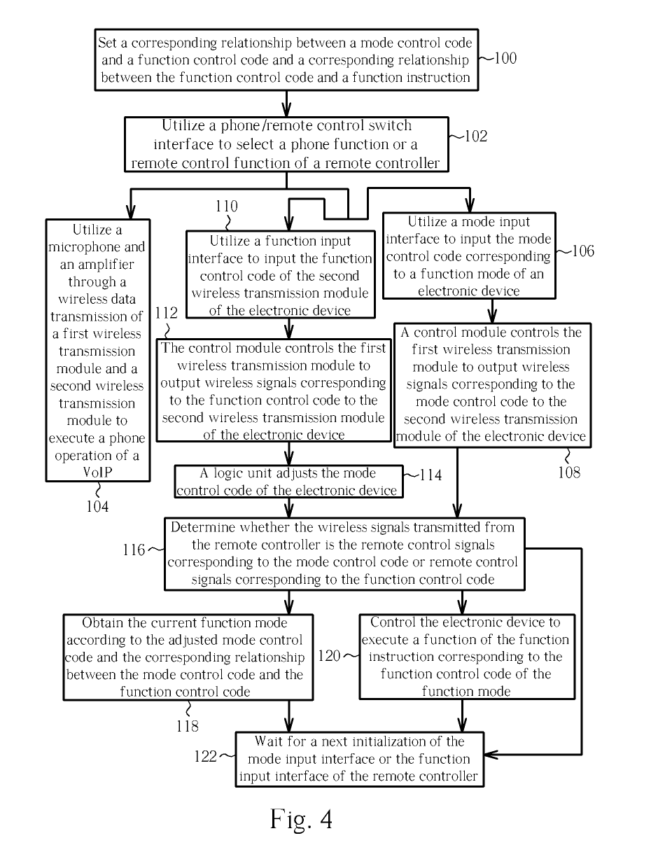

Please refer to FIG. 4. FIG. 4 illustrates to a flowchart of the remote controller 32 remotely controlling the electronic device 34 according to the remote control system 30 of the present invention. The method of the present invention includes the following steps:

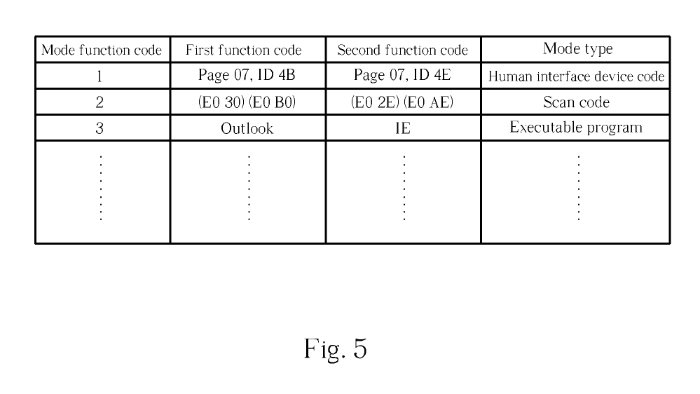

Step 100: set a corresponding relationship between the mode control code and the function control code and a corresponding relationship between the function control code and the function instruction within the memory 54 of the electronic device 34. As an example, please refer to FIG. 5. FIG. 5 is a diagram illustrating the corresponding relationship between the mode control code and the function control code and a corresponding relationship between the function control code and the function instruction within the memory 54;

Step 102: utilize the phone/remote control switch interface 50 to select the phone function or the remote control function of the remote controller 32, if the remote controller 32 is being switched to the phone function, execute step 104; and if the remote controller 32 is being switched to the remote control function, then execute step 106;

Step 104: at this time the remote controller 32 is being utilized as a VoIP phone, utilize the microphone 46 and the amplifier 48 of the remote controller 32 by a user through the wireless data transmission of the first wireless transmission module 40 and the second wireless transmission module 56 to execute a phone operation of the VoIP;

Step 106: utilize the mode input interface 36 to input the mode control code corresponding to the function mode of the electronic device 34;

Step 108: the control module 42 controls the first wireless transmission module 40 to output the wireless signals corresponding to the mode control code to the second wireless transmission module 56 of the electronic device 34;

Step 110: utilize the function input interface 38 to input the function control code of the function instruction for controlling the electronic device 34;

Step 112: the control module 42 controls the first wireless transmission module 40 to output the wireless signals corresponding to the function control code to the second wireless transmission module 56 of the electronic device 34;

Step 114: the logic unit adjusts the mode control code of the electronic device;

Step 116: the logic unit 58 of the electronic device 34 determines whether the wireless signals transmitted from the remote controller 32 is the remote control signals corresponding to the mode control code or the remote control signals corresponding to the function control code, execute step 118 if the wireless signals is the remote control signals corresponding to the mode control code, execute step 120 if the wireless signals is the remote control signals corresponding to the function control code; if the wireless signals is none of the above-mentioned, execute step 122;

Step 118: the logic unit 58 obtains the current function mode according to the adjusted mode control code and the corresponding relationship between the mode control code and the function control code of FIG. 5;

Step 120: the logic unit 58 compares the current function mode, the function control code data within the remote control signals corresponding to the function control code, and the corresponding relationship between the mode control code and the function control code and the corresponding relationship between the function control code and the function instruction of FIG. 5, and the logic unit 58 controls the electronic device 34 to execute a function of the function instruction corresponding to the function control code of the function mode;

Step 122: wait for a next initialization of the mode input interface 36 or the function input interface 38 of the remote controller 32.

To further explain the steps of the above-mentioned, first the user, at the memory, sets the corresponding relationship of the mode control code and the function control code and the corresponding relationship of the function control code and the function instruction of FIG. 5, or the related corresponding function list has been preset into the memory 54 when the electronic device 34 is being manufactured. Please refer to FIG. 5, each mode control code corresponds to a mode type, and each mode function code (mode type) also corresponds to two function control code, as previously mentioned a mode type can execute two types of function instruction. In FIG. 5, the mode function code can be an index value (such as 1, 2, 3, . . . , N), which can correspond respectively to a first function control code and a second function control code, and the first function control code and the second function control code can correspond respectively to a function instruction. For example, a mode function code “1” corresponds to a human interface device (HID) code, and a first function control code and a second function control code of the mode function code “1” corresponds respectively to “Page 07, ID 4B” and “Page 07, ID 4E” of the HID code, and “Page 07, ID 4B” and “Page 07, ID 4E” corresponds respectively to a function instruction of “Page Up” and “Page Down”, thus this function is applicable to software such as presentation software or word processing software. The mode function code “2” corresponds to a scan code, and a first function control code and a second function control code of the mode function code “2” corresponds to “(E0 30)(E0 B0)” and “(E0 2E)(E0 AE)” of the scan code, and “(E0 30)(E0 B0)” and “(E0 2E)(E0 AE)” corresponds respectively to a function instruction of “Volume Up” and “Volume Down”, thus the function is applicable to multi-media software. Furthermore, the mode function code “3” corresponds to executing an applicable software, and a first function control code and a second function control code of the mode function code “3” corresponds respectively to a function instruction of initializing “Outlook” and initializing “Internet Explorer”.

Next, the user can utilize the phone/remote control switching interface 50 to select whether to utilize the phone function or remote control function of the remote controller 32. If the user switches to the phone function, then the remote controller is utilized as the VoIP phone, at this time the microphone 46 of the remote controller 32 can convert the sound waves from the user's conversation into audio signals, and the audio signals are then transmitted to the sound processing unit 44. Next, the sound processing unit 44 can control the first wireless transmission module 40 to transmit the audio signals to the second wireless transmission module 56 in a wireless manner, the electronic device 34 then transmits the audio signals to another user on the other end through a VoIP technology. Alternatively, the electronic device 34 can receive audio signals from the other user on the other end through the VoIP technology, and the electronic device 34 controls the second wireless transmission module 56 to transmit the audio signals to the first wireless transmission module 40 in the wireless manner, the sound processing unit 44 can process the audio signals transmitted from the first wireless transmission module 40 and the processed audio signals are then transmitted to the amplifier 48, the amplifier 48 then converts the data transmitted from the sound processing unit 44 into sound waves, hence the user can listen to the conversation from the other user at the other end. The wireless data transmission method of the first wireless transmission module 40 and the second wireless transmission module 56 allows the user to utilize the remote controller 32 to perform the phone operation of the VoIP phone.

If the user switches the phone/remote control switching interface 50 to select the remote control function, the user can utilize the mode input interface 36 to input the mode control code corresponding to the function mode of the electronic device 34. Next, the control module 42 will control the first wireless transmission module 40 to output the wireless signals corresponding to the mode control code to the second wireless transmission module 56 of the electronic device 34. For example, the mode input interface 36 can be designed to be presented as a keypad, and each time the user presses the mode input interface 36, the control module 42 will control the first wireless transmission module to output the wireless signals corresponding to the mode control code to the second wireless transmission module 56 of the electronic device 34 After the logic unit 58 of the electronic device 34 at the second wireless transmission module 56 receives the wireless signals corresponding to the mode control code, the original mode function code stored in the electronic device 34 will be adjusted, such as the current value of the index value can be accumulated, and after the index value is accumulated to a greatest value, the value returns to zero (returns to the index value “1”) to become a pattern cycle. Therefore, the user can change the mode function code stored in the electronic device through the mode input interface 36 to switch the electronic device 34 to a remote control mode. Furthermore, the user can also utilize the function input interface 38 to input the function control code of the function instruction for controlling the electronic device 34. Next, the control module 42 will control the first wireless transmission module 40 to output the wireless signals corresponding to the function control code to the second wireless transmission module 56 of the electronic device 34.

The logic unit 58 of the electronic device 34 will determine whether the wireless signals transmitted from the remote controller 30 is the remote control signals corresponding to the mode control code or the remote control signals corresponding to the function control code. If the wireless signals are the remote control signals corresponding to the mode control code, then the logic unit 58 obtains the current function mode according to the adjusted mode control code and the corresponding relationship between the mode control code and the function control code of FIG. 5. The adjusted mode control code is then temporarily stored within a memory as a reference for changing the mode control code of the electronic device 34 when the mode input interface 36 of the remote controller 32 is being initialized, or as a reference for providing the current function mode of the electronic device 34 when the function input interface 38 of the remote controller 32 is being initialized.

If the wireless signals transmitted from the remote controller 32 is the remote control signals corresponding to the function control code, the logic unit 58 controls the electronic device 34 to execute a function of the function instruction corresponding to the function control code of the function mode according to the current function mode (the newest mode control code stored within the electronic device 34). The function control code data within the remote control signals corresponding to the function control code received by the second wireless transmission module 56, and the corresponding relationship between the mode control code and the function control code and the corresponding relationship between the function control code and the function instruction of FIG. 5. For example, please refer to FIG. 5. When the newest mode control code stored within the electronic device 34 is being “1”, in another words the electronic device 34 is at a first type of function mode, if the user presses a keypad corresponding to the second function control code of the function input interface 36 of the remote controller 32, at this time the second wireless transmission module 56 will receive the remote control signals corresponding to the second function control code transmitted from the first wireless transmission module 40. Thus, the logic unit 58 will execute the function corresponding to the function instruction of the second function control code under the first function mode, which means that executing the function instruction of “Page Down” corresponding to “Page 07, ID 4E”, such that the image shown on the electronic device 34 can execute a page down action. Lastly, the logic unit 58 continues to wait for a next initialization of the mode input interface 36 or the function input interface 38 of the remote controller 32, and the steps of the above-mentioned are re-executed.

In conclusion, as the function key of the remote control system of the present invention does not send out a corresponding key (such as a HID code) that can directly process command like a main control end operating system, the present invention can only receive the remote control signal transmitted from the remote controller at the remote control end to further decode the function instruction corresponding to the function key of the remote controller. Thus, the function key of the remote controller has greater flexibility thereby providing a more flexible remote control selection to the user, and the corresponding remote control operation can be performed at a different mode. The remote controller only requires a single set of the operation interface so that the size of the remote controller can be reduced. Furthermore, the corresponding relationship of the remote control function is stored within the main control end of the electronic device, and not within the remote controller end. Therefore, when manufacturing of the remote controller is being outsourced the confidentiality of the electronic device operation function will can remain confidential rather than be hared with the 3rd party manufacturer.

In comparison to the conventional remote control system and its related remote control method, the remote control system and its related remote control method of the present invention combines the VoIP function and the remote control function of controlling the electronic device when the electronic device is at a different mode, thus the remote controller achieves the design objectives of improved mobility, simplicity, and multi-functional, and the present invention overcomes the defect of the conventional remote controller where each keypad only corresponds to one function, while at the same time the present invention overcomes the inconvenience of a bulky remote controller having too many keypads.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A remote control system capable of controlling an electronic device at different modes, comprising:
a remote controller comprising:
a mode input interface for inputting a mode control code corresponding to a function mode of the electronic device;
a function input interface for inputting a function control code corresponding to a function instruction of the electronic device;
a first wireless transmission module for transmitting wireless signals; and
a control module for controlling the first wireless transmission module to output the wireless signals corresponding to the mode control code when the mode input interface receives the mode control codes; and
an electronic device comprising:
a memory for storing a corresponding relationship between the mode control code and the function control code and a corresponding relationship between the function control code and the function instruction;
a second wireless transmission module for receiving the wireless signals corresponding to the mode control code transmitted from the first wireless transmission module or for receiving the wireless signals corresponding to the function control code transmitted from the first wireless transmission module; and
a logic unit for controlling the electronic device to execute a function of the function instruction corresponding to the function control code of the mode control code according to the wireless signals corresponding to the mode control code received by the second wireless transmission module, the wireless signals corresponding to the function control code received by the second wireless transmission module, the corresponding relationship between the mode control code and the function control code stored in the memory, and the corresponding relationship between the function control code and the function instruction stored in the memory.

2. The remote control system of claim 1 wherein the remote controller further comprises:
a sound processing unit coupled to the first wireless transmission module for processing audio signals;
a microphone coupled to the sound processing unit for converting sound waves into an audio signal and for transmitting the audio signal to the sound processing unit, wherein the sound processing unit is capable of controlling the first wireless transmission module to transmit the audio signal to the second wireless transmission module in a wireless manner; and
an amplifier coupled to the sound processing unit for converting data transmitted from the sound processing unit into sound waves.

3. The remote control system of claim 2 wherein the remote controller is a voice over Internet protocol (VoIP) phone.

4. The remote control system of claim 3 wherein the remote controller further comprises a phone/remote control switch interface coupled to the sound processing unit and the control module for switching to a phone function or a remote control function.

5. The remote control system of claim 1 wherein the first wireless transmission module utilizes an infrared transmission technology to transmit the wireless signals to the second transmission module.

6. The remote control system of claim 1 wherein the first wireless transmission module utilizes a Bluetooth technology wireless area network protocol to transmit the wireless signals to the second transmission module.

7. The remote control system of claim 1 wherein the function instruction corresponding to the function control code is a human interface device (HID) code.

8. The remote control system of claim 1 wherein the function instruction corresponding to the function control code is a scan code.

9. The remote control system of claim 1 wherein the function instruction corresponding to the function control code is an executable program instruction.

10. The remote control system of claim 1 wherein the electronic device is a notebook computer.

11. A remote control method capable of controlling an electronic device at different modes, comprising:
(a) utilizing a wireless communication technology to transmit wireless signals corresponding to a mode control code corresponding to a function mode of the electronic device to the electronic device;
(b) utilizing the wireless communication technology to transmit the wireless signals corresponding a function control code corresponding to a function instruction of the electronic device; and
(c) the electronic device executing a function of the function instruction corresponding to the function control code of the mode control code.

12. The method of claim 11 further comprising setting a corresponding relationship between the mode control code and the function control code and a corresponding relationship between the function control code and the function instruction.

13. The method of claim 12 wherein step (c) comprises executing the function of the function instruction corresponding to the function control code of the mode control code by the electronic device according to the corresponding relationship between the mode control code and the function control code and the corresponding relationship between the function control code and the function instruction.

14. The method of claim 13 further comprising:
(d) after executing step (a), adjusting the mode control code of the electronic device, and comparing the corresponding relationship among the adjusted mode control code, the function control code, and the function instruction;
wherein step (c) comprises the electronic device executing the function of the function instruction corresponding to the function control code of the mode control code according to the result of step (d).

15. The remote control system of claim 11 wherein the function instruction corresponding to the function control code is a human interface device (HID) code.

16. The remote control system of claim 111 wherein the function instruction corresponding to the function control code is a scan code.

17. The remote control system of claim 11 wherein the function instruction corresponding to the function control code is an executable program instruction.
